(19) United States
(12) Patent Application Publication
(10) Pub. No.: US 2016/0292174 A1
(43) Pub. Date: Oct. 6, 2016

(54) FILE SCANNING METHOD AND DEVICE

(71) Applicant: LE SHI ZHI XIN ELECTRONIC TECHNOLOGY (TIANJIN) LIMITED, Beijing (CN)

(72) Inventors: Song HE, Beijing (CN); Fan LIANG, Beijing (CN)

(21) Appl. No.: 15/037,658

(22) PCT Filed: Nov. 18, 2014
(86) PCT No.: PCT/CN2014/091428

§ 371 Date: May 18, 2016

(30) Foreign Application Priority Data
Nov. 19, 2013 (CN) 201310586497.5

(51) Int. Cl. G06F 17/30

(52) U.S. Cl. CPC G06F 17/30106; G06F 17/30091; G06F 17/3012

(57) ABSTRACT

A file scanning method and device are used for scanning the storage space layer to be scanned at present, obtaining files stored in the storage space layer to be scanned at present, afterwards, calculating the storage paths of the files stored in the storage space layer to be scanned at present, analyzing the files stored in the storage space layer to be scanned at present, obtaining the information of the files stored in the storage space layer to be scanned at present, then judging whether the folders are stored in the storage space layer to be scanned at present, when the folders are stored in the storage space layer to be scanned at present, using the folders as the storage space layer to be scanned at present, and returning to execute above steps until no folders are stored in the storage space layer to be scanned at present, and ending the file scan.

### CROSS-REFERENCE TO RELATED APPLICATIONS

The present application is the national stage of International Application No. PCT/CN2014/091428 filed Nov. 18, 2014, which is based upon and claims priority to Chinese Patent Application No. 201310586497.5, named “FILE SCANNING METHOD AND DEVICE” filed on 19 Nov. 2013, the entire contents of all of which are incorporated herein by reference.

### FIELD OF TECHNOLOGY

The present application generally relates to the technical field of data processing, in particular to a file scanning method and device.

### BACKGROUND

In order to facilitate looking up, a user usually performs tiered storage in the form of a folder when storing a file such as a document, audio, or video onto a computer hard disk, a U disk, or an SD card. Assuming that a computer's D disk is the first layer of storage space, as shown in FIG. 1a, the content stored in the first layer of storage space is a folder 1, a folder 2, a file 1 and a file 2, in FIG. 1b, part of the content stored in a second layer of storage space is a file 5 stored in folder 2 and a folder 3, a file 3 and a file 4 stored in folder 1 (not shown in the drawing) further belong to the second layer of storage space, and in FIG. 1c, the content stored in a third layer of storage space is a file 6 stored in folder 3.

Generally, when the files stored in a storage device are scanned, the storage path of each file is obtained by a recursive algorithm, after the storage paths of all files are obtained, specific information such as file type and resolution of all files are analyzed from the bottom layer. For example, if the file in the computer's D disk is about to be scanned, the storage paths of file 1, file 2, file 3, file 4, file 5 and file 6 are obtained by the recursive algorithm firstly, after the storage paths of all the files are obtained, specific information of file 1, file 2, file 3, file 4, file 5 and file 6 is analyzed from the bottom layer once, and finally, file 1, file 2, file 3, file 4, file 5 and file 6 are displayed in combination with the corresponding specific information, thus finishing the file scanning.

To sum up, generally during file scanning, calculation of the storage paths of the files and analysis of the specific information of the files are separated, the specific information of the files cannot be analyzed until the storage paths of all the files are calculated, besides, the specific information of all the files is analyzed at the same time, thus, when more files require scanning, the scanning time will certainly be longer, and the scanning efficiency is reduced.

### SUMMARY

Considering this, the present application provides a file scanning method and device, so as to overcome the problems of long scanning time and reduced scanning efficiency caused by more files needing to be scanned in the prior art.

In order to solve at least one objective above, the present disclosure discloses technical solutions as below.

A file scanning method, characterized by including:

determining a storage space layer to be scanned at present;

scanning the storage space layer to be scanned at present, and obtaining files stored in the storage space layer to be scanned at present;

calculating the storage paths of the files stored in the storage space layer to be scanned at present;

analyzing the files stored in the storage space layer to be scanned at present, and obtaining the information of the files stored in the storage space layer to be scanned at present;

judging whether folders are stored in the storage space layer to be scanned at present;

using the folders as the next storage space layer when the folders are stored in the storage space layer to be scanned at present, returning to the step of determining the storage space layer to be scanned at present, and determining the next storage space layer as the storage space layer to be scanned at present to execute in sequence; and ending the file scanning when no folders are stored in the storage space layer to be scanned at present.

In a specific embodiment of the present disclosure, after obtaining the information of the files stored in the storage space layer to be scanned at present and before judging whether the folders are stored in the storage space layer to be scanned at present, further including:

displaying the files stored in the storage space layer to be scanned at present.

In a specific embodiment of the present disclosure, calculating the storage paths of the files stored in the storage space layer to be scanned at present including:

calculating the storage paths of the files stored in the storage space layer to be scanned at present by a recursive algorithm.

In a specific embodiment of the present disclosure, analyzing the files stored in the storage space layer to be scanned at present includes:

obtaining the scanning time of the files stored in the storage space layer to be scanned at present; and

analyzing the information of the files stored in the storage space layer to be scanned at present in sequence according to the sequence of the scanning time.

A file scanning device, characterized by including:

a storage space layer to be scanned at present determining module, configured to determine a storage space layer to be scanned at present;

a scanning module, configured to scan the storage space layer to be scanned at present, and obtain files stored in the storage space layer to be scanned at present;

a storage path calculation module, configured to calculate the storage paths of the files stored in the storage space layer to be scanned at present;

an information acquiring module, configured to analyze the files stored in the storage space layer to be scanned at present, and obtain the information of the files stored in the storage space layer to be scanned at present;

a judging module, configured to judge whether folders are stored in the storage space layer to be scanned at present;

a circulation control module, configured to use the folders as the next storage space layer when the folders are stored in the storage space layer to be scanned at present, return to the step of determining the storage space layer to be scanned at present, and determine the next storage space layer as the storage space layer to be scanned at present to execute in sequence; and

an ending control module, configured to end the file scanning when no folders are stored in the storage space layer to be scanned at present.

In a specific embodiment of the present disclosure, further including:

a displaying module, configured to display the files stored in the storage space layer to be scanned at present.

In a specific embodiment of the present disclosure, the storage path calculation module comprises:

a recursive algorithm calculation module, configured to calculate the storage paths of the files stored in the storage space layer to be scanned at present by a recursive algorithm.

In a specific embodiment of the present disclosure, the information acquiring module comprises:

a scanning time acquiring module, configured to obtain scanning time of the files stored in the storage space layer to be scanned at present; and

a file information analyzing module, configured to analyze the information of the files stored in the storage space layer to be scanned at present in sequence according to the sequence of the scanning time.

A file scanning device, including:

at least one processor;

a memory for storing at least one instruction executable by the processor;

wherein the processor is configured to perform:

determining a storage space layer to be scanned at present;

scanning the storage space layer to be scanned at present, and obtaining file stored in the storage space layer to be scanned at present;

calculating a storage path of the file stored in the storage space layer to be scanned at present;

analyzing the file stored in the storage space layer to be scanned at present, and obtaining the information of the file stored in the storage space layer to be scanned at present;

judging whether a folder is stored in the storage space layer to be scanned at present;

using the folder as the next storage space layer when the folder is stored in the storage space layer to be scanned at present, returning to the step of determining the storage space layer to be scanned at present, and determining the next storage space layer as the storage space layer to be scanned at present to execute in sequence; and

ending the file scanning when no folder is stored in the storage space layer to be scanned at present.

Known from above technical solutions, compared with the prior art, according to the present application, the scanning of the files, the calculation of the file paths and the analysis of the file information are performed in a tiered manner, the scan of the next layer file, and the calculation of the last layer file path and the analysis of the file information can be performed at the same time, thus reducing the scanning time and improving the scanning efficiency.

### BRIEF DESCRIPTION OF THE DRAWINGS

In order to more clearly understand above objects, features and advantages of the disclosure, hereinafter the disclosure will be further described in detail in conjunction with accompanying drawings and specific implementations. Obviously, the drawings described hereinafter are only embodiments of the present disclosure, a skilled person in the art may obtain other drawings according to the provided drawings without creativity.

FIG. 1 is a schematic diagram of a storage space layer in the prior art disclosed by the background technology of the present application;

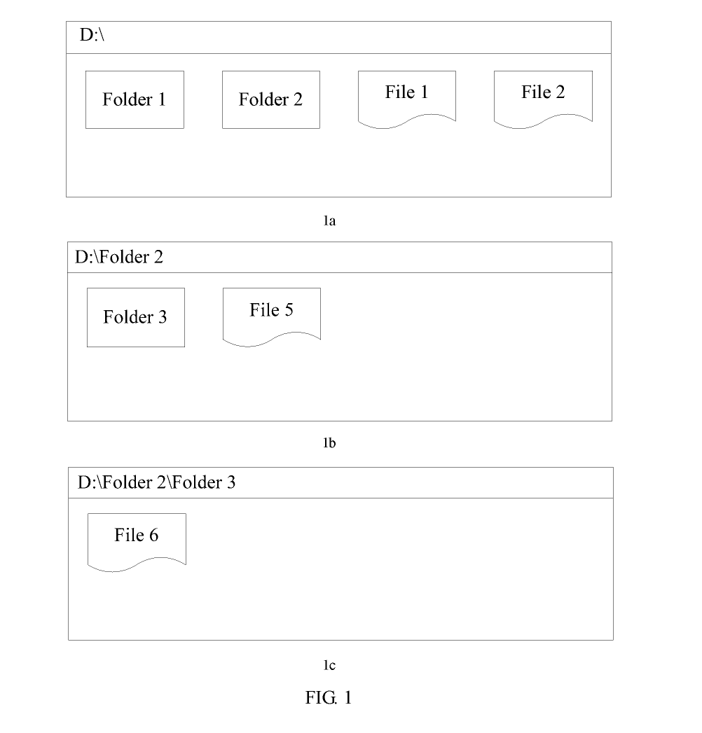

FIG. 2 is a schematic diagram of a specific flow of a file scanning method disclosed by one embodiment of the present application;

FIG. 3 is a schematic diagram of a specific flow of a file scanning method disclosed by another embodiment of the present application;

FIG. 4 is a schematic diagram of a specific structure of a file scanning device disclosed by one embodiment of the present application;

FIG. 5 is a schematic diagram of a specific structure of a file scanning device disclosed by another embodiment of the present application.

### DESCRIPTION OF THE EMBODIMENTS

Known from the background technology, in the prior art, during file scanning, calculation of the storage paths of the files and analysis of the specific information are separated, the specific information of the files cannot be analyzed until the storage paths of all the files are calculated, besides, the specific information of all the files is analyzed at the same time, hence, when more files require scanning, the scanning time will certainly be long, and the scanning efficiency is reduced.

Therefore, the present application discloses a file scanning method and device, which are used for scanning a storage space layer to be scanned at present, obtaining files stored in the storage space layer to be scanned at present, afterwards, calculating the paths of the files stored in the storage space layer to be scanned at present, analyzing the files stored in the storage space layer to be scanned at present, obtaining the information of the files stored in the storage space layer to be scanned at present, then judging whether the folders are stored in the storage space layer to be scanned at present, when the folders are stored in the storage space layer to be scanned at present, using the folders as the storage space layer to be scanned at present, and returning to execute the above steps until no folders are stored in the storage space layer to be scanned at present, and ending the file scan. Through this method, the scanning of the files, the calculation of the file paths and the analysis of the file information are performed in a tiered manner, and the scanning of the next layer file, the calculation of the last layer file path, and the analysis of the file information can be performed at the same time, thus reducing the scanning time and improving the scanning efficiency. A specific flow about the file scanning method and a specific structure of the file scanning device will be described in detail by the following embodiments.

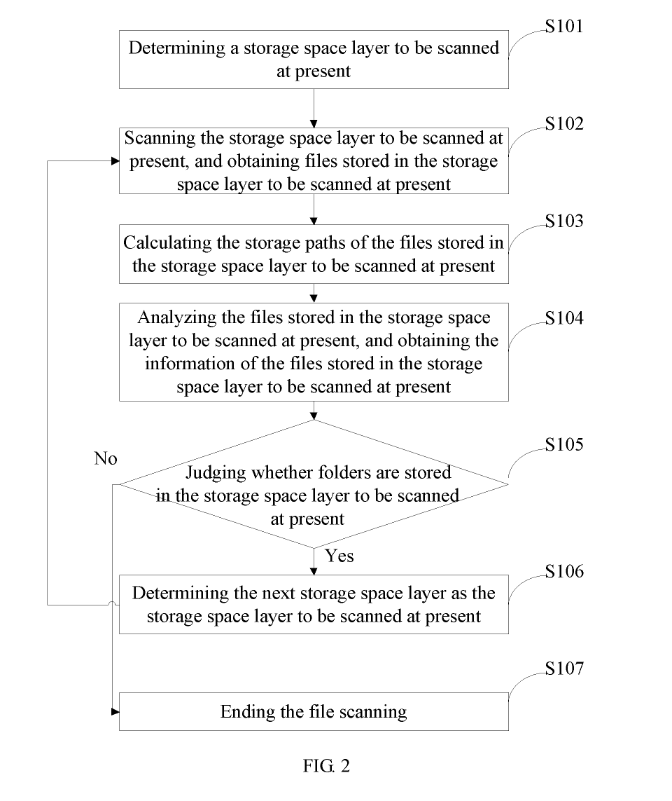

Please refer to FIG. 2, which is a schematic diagram of the flow of a file scanning method disclosed by one embodiment of the present application, and the file scanning method includes the following steps:

S101: determining a storage space layer to be scanned at present.

S102: scanning the storage space layer to be scanned at present, and obtaining files stored in the storage space layer to be scanned at present.

S103: calculating the storage paths of the files stored in the storage space layer to be scanned at present.

S104: analyzing the files stored in the storage space layer to be scanned at present, and obtaining the information of the files stored in the storage space layer to be scanned at present.

S105: judging whether folders are stored in the storage space layer to be scanned at present, when the folders are stored in the storage space layer to be scanned at present, executing step S106, and when no folders are stored in the storage space layer to be scanned at present, executing step S107.

S106: using the folders as the next storage space layer, determining the next storage space layer as the storage space layer to be scanned at present, returning to execute the step S102, and executing S103-S105 in sequence.

S107: ending the file scanning.

In conclusion, the present embodiment discloses a file scanning method, comprising scanning the storage space layer to be scanned at present, obtaining files stored in the storage space layer to be scanned at present, afterwards, calculating the paths of the files stored in the storage space layer to be scanned at present, analyzing the files stored in the storage space layer to be scanned at present, obtaining the information of the files stored in the storage space layer to be scanned at present, then judging whether folders are stored in the storage space layer to be scanned at present, when the folders are stored in the storage space layer to be scanned at present, using the folders as the storage space layer to be scanned at present, and returning to execute the above steps until no folders are stored in the storage space layer to be scanned at present, and ending the file scan. Through the method, the scanning of the files, the calculation of the file paths and the analysis of the file information are performed in a tiered manner, and the scanning of the next layer file, the calculation of the last layer file path, and the analysis of the file information can be performed at the same time, thus reducing the scanning time and improving the scanning efficiency.

Based on the above embodiment disclosed by the present application, the present application further discloses a more specific file scanning method, which will be described in detail by the following embodiment.

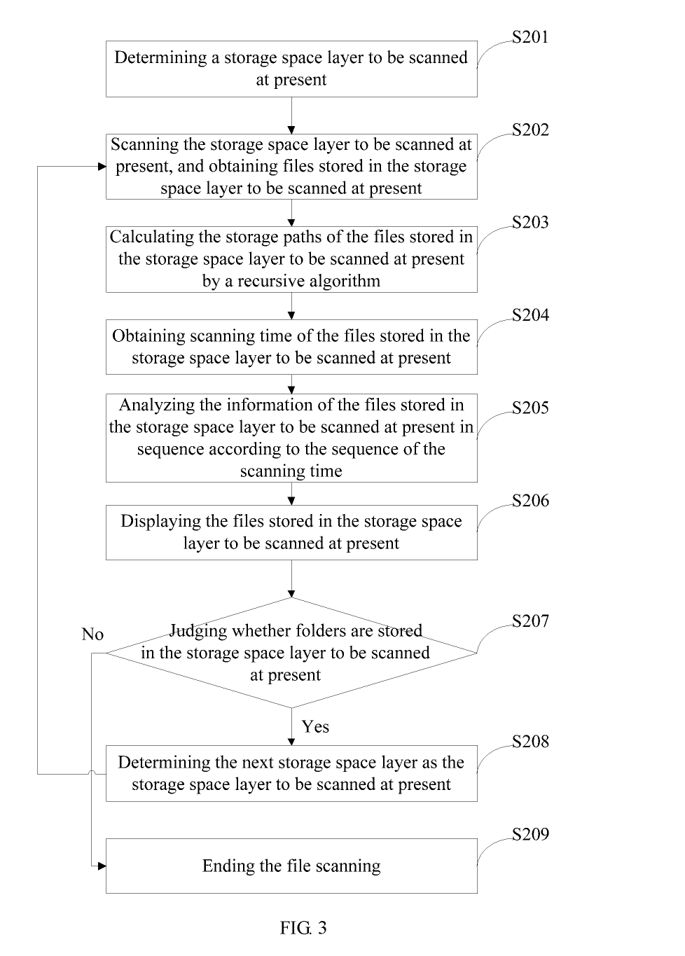

Please refer to FIG. 3, which is a schematic diagram of a specific flow of a file scanning method disclosed by another embodiment of the present application and the file scanning method includes the following steps:

S201: determining a storage space layer to be scanned at present.

S202: scanning the storage space layer to be scanned at present, and obtaining files stored in the storage space layer to be scanned at present.

S203: calculating the storage paths of the files stored in the storage space layer to be scanned at present by a recursive algorithm.

S204: obtaining the scanning time of the files stored in the storage space layer to be scanned at present.

S205: analyzing the information of the files stored in the storage space layer to be scanned at present in sequence according to the sequence of the scanning time.

S206: displaying the files stored in the storage space layer to be scanned at present.

S207: judging whether the folders are stored in the storage space layer to be scanned at present, when the folders are stored in the storage space layer to be scanned at present, executing step S208, and when no folders are stored in the storage space layer to be scanned at present, executing step S209.

S208: using the folders as the next storage space layer, determining the next storage space layer as the storage space layer to be scanned at present, returning to step S202, and executing S203-S207 in sequence.

S209: ending the file scan.

In conclusion, the present embodiment discloses a more specific file scanning method, through which file scanning and file displaying are performed at the same time, through the method, the scanning of the files, the calculation of the file paths and the analysis of the file information are performed in a tiered manner, and the scanning of the next layer file, the calculation of the last layer file path, and the analysis of the file information can be performed at the same time, thus reducing the scanning time and improving the scanning efficiency.

The above embodiments disclosed by the present application describe the method in detail, the method in the present application can be realized by a device in multiple forms, therefore, the present application further discloses a device described in detail by the following specific embodiment.

The present application provides a computer readable recording medium on which a program for executing the above method is recorded.

The computer readable recording medium includes any mechanism for storing or transferring information in a computer (for example, a computer) readable manner. For example, the machine readable recording medium includes Read Only Memory (ROM), Random Access Memory (RAM), disk storage media, optical storage media, flash storage media, transmission signals in electric, optical, acoustic or other forms (for example, carriers, infrared signals and digital signals), etc.

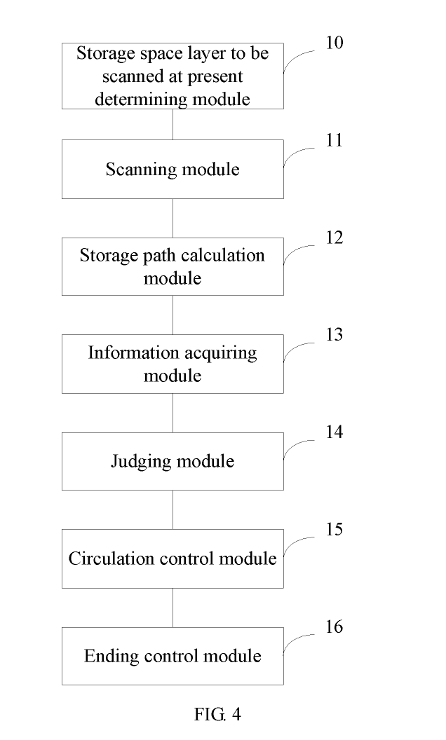

Please refer to FIG. 4 which is a schematic diagram of a specific structure of a file scanning device disclosed by one embodiment of the present application, and the file scanning device includes the following modules:

a storage space layer to be scanned at present determining module 10, configured to determine a storage space layer to be scanned at present;

a scanning module 11, configured to scan a storage space layer to be scanned at present, and obtain files stored in the storage space layer to be scanned at present;

a storage path calculation module 12, configured to calculate the storage paths of the files stored in the storage space layer to be scanned at present;

an information acquiring module 13, configured to analyze the files stored in the storage space layer to be scanned at present, and obtain the information of the files stored in the storage space layer to be scanned at present;

a judging module 14, configured to judge whether folders are stored in the storage space layer to be scanned at present;

a circulation control module 15, configured to use the folders as the next storage space layer when the folders are stored in the storage space layer to be scanned at present, determine the next storage space layer as the storage space layer to be scanned at present, and return to the step of scanning the storage space layer to be scanned at present to execute in sequence; and

an ending control module 16, configured to end the file scanning when no folders are stored in the storage space layer to be scanned at present.

It should be explained that realization of the functions of each of the above modules refers to the related description in embodiment I of the method, which is not repeated in the present embodiment.

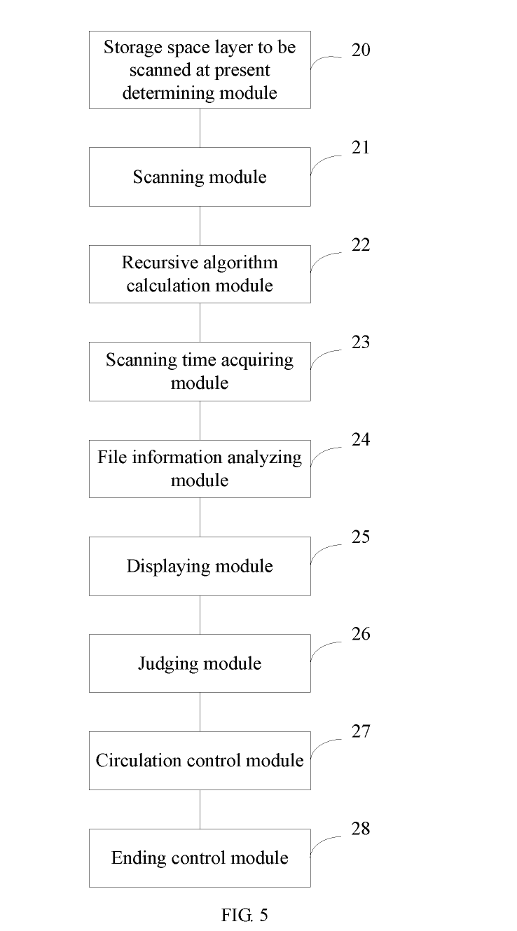

Please refer to FIG. 5, which is a schematic diagram of the specific structure of a file scanning device disclosed by another embodiment of the present application, and the file scanning device specifically includes:

a storage space layer to be scanned at present determining module 20, configured to determine a storage space layer to be scanned at present;

a scanning module 21, configured to scan the storage space layer to be scanned at present, and obtain files stored in the storage space layer to be scanned at present;

a recursive algorithm calculation module 22, configured to calculate the storage paths of the files stored in the storage space layer to be scanned at present by a recursive algorithm;

a scanning time acquiring module 23, configured to obtain the scanning time of the files stored in the storage space layer to be scanned at present;

a file information analyzing module 24, configured to analyze the information of the files stored in the storage space layer to be scanned at present in sequence according to the sequence of the scanning time;

a displaying module 25, configured to display the files stored in the storage space layer to be scanned at present;

a judging module 26, configured to judge whether folders are stored in the storage space layer to be scanned at present;

a circulation control module 27, configured to use the folders as the next storage space layer when the folders are stored in the storage space layer to be scanned at present, determine the next storage space layer as the storage space layer to be scanned at present, and return to the step of scanning the storage space layer to be scanned at present to execute in sequence; and

an ending control module 28, configured to end the file scanning when no folders are stored in the storage space layer to be scanned at present.

It should be explained that realization of the functions of each of the above modules refers to the related description in embodiment II of the method, which is not repeated in the present embodiment.

In conclusion, the present application discloses a file scanning method and device, which are used for scanning the storage space layer to be scanned at present, obtaining files stored in the storage space layer to be scanned at present, afterwards, calculating the storage paths of the files stored in the storage space layer to be scanned at present, analyzing the files stored in the storage space layer to be scanned at present, obtaining the information of the files stored in the storage space layer to be scanned at present, then judging whether the folders are stored in the storage space layer to be scanned at present, when the folders are stored in the storage space layer to be scanned at present, using the folders as the storage space layer to be scanned at present, and returning to execute above steps until no folders are stored in the storage space layer to be scanned at present, and ending the file scan. Through the method, the scanning of the files, the calculation of the file paths and the analysis of the file information are performed in a tiered manner, and the scanning of the next layer file, the calculation of the last layer file path, and the analysis of the file information can be performed at the same time, thus reducing the scanning time and improving the scanning efficiency.

The embodiments in the disclosure is described step by step, the important part of each embodiment mainly lies in the difference between other embodiments, the same or similar part between each embodiments may be referred to each other. The device embodiments are similar to the method embodiments, thusly the description is relatively simple, the related part may be referred to the parts of the method embodiments.

The method or algorithm described in the embodiments of the present disclosure may be implemented by hardware, software implemented by processor or their combination. The software module may be stored in random access memory (RAM), read-only memory (ROM), electrically programmable ROM, Electrically Erasable Programmable ROM, register, hard disk, portable disk, CD-ROM or storage medium having other forms in the technical area.

The illustration of the embodiment of the present disclosure may allow a skilled person in the art to realize or use the application. The various amendments to the embodiments are apparently to a skilled person in the art. The basic principle defined in the present disclosure may be realized in other embodiments without departure from the spirit or scope of the present disclosure. Thusly, the present disclosure is not limited to be the embodiments of the present disclosure, instead, it conforms to the widest scope which is in accordance with the principle and novelty disclosed in the present disclosure.

1. A file scanning method, comprising:
determining a storage space layer to be scanned at present;
scanning the storage space layer to be scanned at present, and obtaining file stored in the storage space layer to be scanned at present;
calculating a storage path of the file stored in the storage space layer to be scanned at present;
analyzing the file stored in the storage space layer to be scanned at present, and obtaining the information of the file stored in the storage space layer to be scanned at present;
judging whether folder is stored in the storage space layer to be scanned at present;
using the folder as the next storage space layer when the folder is stored in the storage space layer to be scanned at present, returning to the step of determining the storage space layer to be scanned at present, and determining the next storage space layer as the storage space layer to be scanned at present to execute in sequence; and
ending the file scanning when no folder is stored in the storage space layer to be scanned at present.

2. The method according to claim 1, wherein after obtaining the information of the file stored in the storage space layer to be scanned at present and before judging whether the folder is stored in the storage space layer to be scanned at present, the method further comprises:
displaying the file stored in the storage space layer to be scanned at present.

3. The method according to claim 1 or 2, wherein calculating the storage path of the file stored in the storage space layer to be scanned at present comprises:
calculating the storage path of the file stored in the storage space layer to be scanned at present by a recursive algorithm.

4. The method according to claim 1 or 2, wherein analyzing the file stored in the storage space layer to be scanned at present comprises:
obtaining the scanning time of the file stored in the storage space layer to be scanned at present; and
analyzing information of the file stored in the storage space layer to be scanned at present in sequence according to the sequence of the scanning time.

5. A file scanning device, characterized by comprising:
at least one processor;
a memory for storing at least one instruction executable by the processor;
wherein the processor is configured to perform:
determining a storage space layer to be scanned at present;
scanning the storage space layer to be scanned at present, and obtaining file stored in the storage space layer to be scanned at present;
calculating a storage path of the file stored in the storage space layer to be scanned at present;
analyzing the file stored in the storage space layer to be scanned at present, and obtaining the information of the file stored in the storage space layer to be scanned at present;
judging whether a folder is stored in the storage space layer to be scanned at present;
using the folder as the next storage space layer when the folder is stored in the storage space layer to be scanned at present, returning to the step of determining the storage space layer to be scanned at present, and determining the next storage space layer as the storage space layer to be scanned at present to execute in sequence; and
ending the file scanning when no folder is stored in the storage space layer to be scanned at present.

6. The device according to claim 5, further comprising:
displaying the file stored in the storage space layer to be scanned at present.

7. The device according to claim 5, characterized in that calculating a storage path of the file stored in the storage space layer to be scanned at present further comprises:
calculating the storage path of the file stored in the storage space layer to be scanned at present by a recursive algorithm.

8. The device according to claim 5, wherein analyzing the file stored in the storage space layer to be scanned at present, and obtaining the information of the file stored in the storage space layer to be scanned at present further comprises:
obtaining scanning time of the file stored in the storage space layer to be scanned at present; and
analyzing information of the file stored in the storage space layer to be scanned at present in sequence according to the sequence of the scanning time.

9. A non-transitory computer readable recording medium having computer programs stored thereon that, when executed by one or more processors of a device, cause the device to perform:
determining a storage space layer to be scanned at present;
scanning the storage space layer to be scanned at present, and obtaining file stored in the storage space layer to be scanned at present;
calculating a storage path of the file stored in the storage space layer to be scanned at present;
analyzing the file stored in the storage space layer to be scanned at present, and obtaining the information of the file stored in the storage space layer to be scanned at present;
judging whether folder is stored in the storage space layer to be scanned at present;
using the folder as the next storage space layer when the folder is stored in the storage space layer to be scanned at present, returning to the step of determining the storage space layer to be scanned at present, and determining the next storage space layer as the storage space layer to be scanned at present to execute in sequence; and
ending the file scanning when no folder is stored in the storage space layer to be scanned at present.

10. (canceled)

11. The method according to claim 2, wherein calculating the storage path of the file stored in the storage space layer to be scanned at present comprises:
calculating the storage path of the file stored in the storage space layer to be scanned at present by a recursive algorithm.

12. The method according to claim 2, wherein analyzing the file stored in the storage space layer to be scanned at present comprises:
obtaining the scanning time of the file stored in the storage space layer to be scanned at present; and
analyzing information of the file stored in the storage space layer to be scanned at present in sequence according to the sequence of the scanning time.
